(19) United States
(12) Patent Application Publication
(10) Pub. No.: US 2025/0216006 A1
(43) Pub. Date: Jul. 3, 2025

(54) HOSE AND METHOD OF MANUFACTURING THEREOF

(71) Applicant: Imperial Auto Industries Limited, Faridabad (IN)

(72) Inventor: Shailendra SINGH SOLANKY, Faridabad (IN)

(73) Assignee: Imperial Auto Industries Limited, Faridabad, HR (IN)

(21) Appl. No.: 18/850,514

(22) PCT Filed: Jun. 24, 2022
(86) PCT No.: PCT/IN2022/050577

§ 371 Date: Sep. 24, 2024

(30) Foreign Application Priority Data
Mar. 30, 2022 (IN) 202211018992

(51) Int. Cl. F16L 11/08; B29C 48/09; B29C 48/151; B29C 48/21; B29K 21/00; B29K 105/24; B29L 23/00

(52) U.S. Cl. CPC F16L 11/08; B29C 48/09; B29C 48/151; B29C 48/21; B29K 2021/003; B29K 2105/24; B29K 2313/00; B29L 2023/005

(57) ABSTRACT

A hose (100) has an extruded inner layer (102), an intermediate layer (104) and an extruded outer layer (106). The extruded inner layer (102) provides a path for flow of a fluid. The intermediate layer (104) is made of a reinforcement material, and is circumferentially situated over the extruded inner layer (102). The extruded outer layer (106) is circumferentially situated over the intermediate layer (104). The extruded inner layer (102) and the extruded outer layer (106) are made of a first thermoplastic vulcanizate (TPV) and a second thermoplastic vulcanizate (TPV), respectively, and each are surface treated using a chemical solution.

### FIELD OF THE INVENTION

The embodiments of the present invention generally relate to hoses and tubes, and more particularly, the embodiments of the present invention relate to a low pressure reinforced thermoplastic vulcanizate hose and a manufacturing method thereof.

### BACKGROUND

Hoses used to transport fluids are well known in the industry. In addition to extreme temperatures, such hoses are subjected to a variety of fluid mixtures, fuel additives, and caustic materials. The hoses are extensively used in industrial applications, commercial applications and automotive applications.

In general, the hoses are manufactured from various polymeric materials such as natural rubber, synthetic rubber such as styrene-butadiene rubber (SBR), neoprene, ethylene-propylene rubber (EPR), silicone rubber (VMQ), butyl rubber, nitrile-butadiene rubber (NBR), ethylene propylene diene monomer (EPDM) and the like; blends of such natural and synthetic rubbers. Depending on the application, the hoses must have certain characteristics, such as a high degree of flexibility, light weight and inexpensive to manufacture, and be able to accommodate hot fluids without causing undue degradation.

Hoses, in particular, have traditionally been made of EPDM rubber or silicone rubber. For the manufacturer, such rubber compounds present a number of challenges. The challenges include heavy weighing hoses due to high density of such rubber compounds, prone to electrochemical degradation resulting in inconsistent and unreliable hoses, and the like.

In view of the above, there remains a need for a novel and an inventive hose that can overcome the above-mentioned limitations.

### OBJECT OF THE INVENTION

An object of the present invention is to provide a method of manufacturing a hose.

Another object of the present invention is to provide a low pressure reinforced thermoplastic vulcanizate hose.

Another object of the present invention is to provide a hose having better electrochemical resistance.

Another object of the present invention is to provide a hose having light weight.

### SUMMARY OF THE INVENTION

According to an aspect of the present invention, a method of manufacturing a hose is disclosed. The method includes performing a surface treatment of a first thermoplastic vulcanizate (TPV) and a second thermoplastic vulcanizate (TPV) using a chemical solution. In addition, the method includes extruding the first TPV to form an extruded inner layer of the hose. The extruded inner layer has a first inner circumferential surface and a first outer circumferential surface. Further, the method includes forming an intermediate layer made of a reinforcement material over the extruded inner layer. The intermediate layer has a second inner circumferential surface and a second outer circumferential surface. Furthermore, the method includes passing the extruded inner layer along with the intermediate layer through a hot channel to soften the first TPV. Moreover, the method includes extruding the second TPV to form an extruded outer layer of the hose. The extruded outer layer has a third inner circumferential surface and a third outer circumferential surface. Also, the method includes applying a vacuum pressure during extrusion of the second TPV to provide adhesive strength to the hose.

In accordance with an embodiment of the present invention, the first TPV may be extruded at a temperature range of 170° C. to 240° C. to form the extruded inner layer of the hose.

In accordance with an embodiment of the present invention, the intermediate layer may be braided, knitted or spiralled over the extruded inner layer.

In accordance with an embodiment of the present invention, the reinforcement material may be selected from a group consisting of polyester, nylon, and aramid.

In accordance with an embodiment of the present invention, the second TPV may be extruded at a temperature range of 170° C. to 240° C. to form the extruded outer layer of the hose.

In accordance with an embodiment of the present invention, the chemical solution may be a combination of Toluene, Cyclohexane, Tetra Hydrofuran (THF) and Methoxyropyl Acetate.

In accordance with an embodiment of the present invention, the hot channel may have a temperature in a range of 200° C. to 300° C.

In accordance with an embodiment of the present invention, the first TPV and the second TPV each may have a density of about 0.90 gram per cubic centimeter.

In accordance with an embodiment of the present invention, the hose may exhibit minimum burst pressure of 10 bars.

In accordance with an embodiment of the present invention, the vacuum pressure may be about 620 millimeter of mercury.

According to another aspect of the present invention, a hose is disclosed. The hose includes an extruded inner layer, an intermediate layer and an extruded outer layer. The extruded inner layer is made of a first TPV. The extruded inner layer provides a path for flow of a fluid. In addition, the intermediate layer is made of a reinforcement material. The intermediate layer is circumferentially situated over the extruded inner layer. Further, the extruded outer layer made of a second TPV. The extruded outer layer is circumferentially situated over the intermediate layer. Furthermore, the first TPV and the second TPV are surface treated using a chemical solution.

It is to be understood that both the foregoing general description and the following detailed description are exemplary and explanatory only and are not restrictive of the invention, as claimed.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following figures, wherein:

FIG. 1 illustrates a perspective view of a hose, in accordance with an exemplary embodiment of the present invention;

FIG. 2 illustrates a cross-sectional view of the hose, in accordance with an exemplary embodiment of the present invention; and

FIG. 3 illustrates a flowchart for a method of manufacturing the hose, in accordance with another exemplary embodiment of the present invention.

### DETAILED DESCRIPTION OF THE PREFERRED EMBODIMENTS

While the present invention is described herein by way of example using embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps, and the like is included in the specification solely for the purpose of Likewise, the term “comprising” is considered synonymous with the terms “including” or “containing” for applicable legal purposes. Any discussion of documents, acts, materials, devices, articles providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawings, wherein reference numerals used in the accompanying drawings correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of materials are identified as suitable for various facets of the implementations. These materials are to be treated as exemplary, and are not intended to limit the scope of the invention.

According to an exemplary embodiment of the present invention, a hose (100) is disclosed which includes a multi-layer structure wherein inner layer and outer layer are made of thermoplastic vulcanizate (TPV). The TPV may have a density of about 0.90 gram per cubic centimeter. The TPV may be surface treated using a chemical solution. The chemical solution may be a combination of Toluene, Cyclohexane, Tetra Hydrofuran (THF) and Methoxyropyl Acetate. The hose 100 (hereinafter referred to as ‘the hose’) may have light weight due to low density of the TPV. A person skilled in the art will appreciate that in automobiles, it is crucial to have lightweight heating and cooling systems to reduce overall weight of vehicles, consequently increasing overall efficiency of the vehicles. Similarly, in heating, ventilation, and air conditioning (HVAC) systems, it is essential to reduce weight for easy installation. The hose (100) may be used in such situations, and may further provide excellent resistance to chemical, environmental and physical degradation. However, it should be noted that the use of the hose (100) may not be limited to the above situations, and the hose (100) may be used in any situation where there is a need of weight reduction and excellent physical properties.

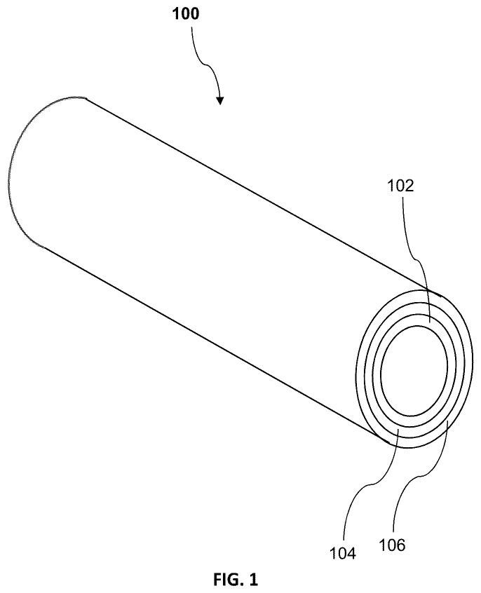

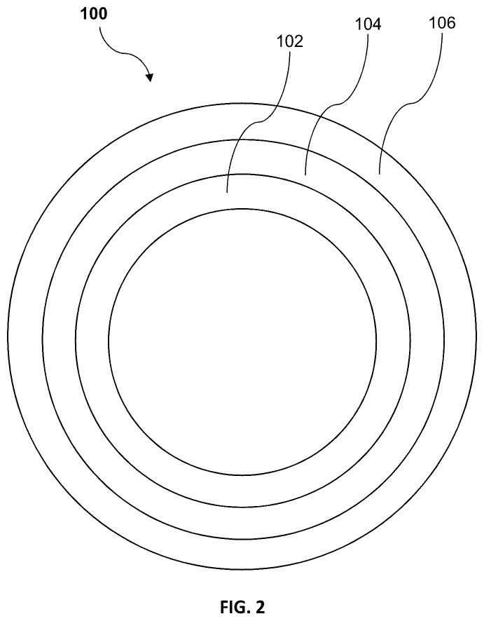

The present invention will now be described in detail with reference to the accompanying drawings. Referring now to FIG. 1 and FIG. 2, a perspective view and a cross-sectional view respectively of the hose (100) is illustrated, in accordance with an exemplary embodiment of the invention. According to an embodiment, the hose (100) may have a substantially cylindrical shape. According to another embodiment, the hose (100) may be of any customized shape. It will be appreciated by a person skilled in the art that, the hose (100) may be used in various kinds of application such as, but not limited to, automobiles, agriculture, marine, heavy industry, cryogenic, HVAC, aviation, medical, and construction.

The hose (100) may include an extruded inner layer (102) made of a first thermoplastic vulcanizate (TPV). The first TPV may be extruded at a temperature range of 170° C. to 240° C. to form the extruded inner layer (102) of the hose (100). According to an embodiment, the extruded inner layer (102) may have a substantially cylindrical shape. According to another embodiment, the extruded inner layer (102) may be of any customized shape. It will be appreciated by a person skilled in the art that the shape and size of the extruded inner layer (102) may vary according to the overall design of the hose (100), and may not be limited to the embodiment shown in the figures. Moreover, it should be noted that the extruded inner layer (102) may be made of the first TPV which enables reduction in overall weight of the hose (100) and provides resistance against chemical degradation. The first TPV may have a hardness between 64 shore A and 87 shore A.

The extruded inner layer (102) may provide a path for flow of a fluid. For the purpose of explanation, the fluid may be a coolant flowing inside the extruded inner layer (102) of the hose (100) for thermal management of batteries of electric vehicles. In certain embodiments, the fluid may be any vehicle fuels. The extruded inner layer (102) may have has a first inner circumferential surface and a first outer circumferential surface. The first inner circumferential surface of the extruded inner layer (102) may form the path through which the fluid flows.

The hose (100) may include an intermediate layer (104) made of a reinforcement material. According to an embodiment, the intermediate layer (104) may have a substantially cylindrical shape. According to another embodiment, the intermediate layer (104) may be of any customized shape. It will be appreciated by a person skilled in the art that the shape and size of the intermediate layer (104) may vary according to the overall design of the hose (100), and may not be limited to the embodiment shown in the figures. Moreover, it should be noted that the intermediate layer (104) may be made of the reinforcement material which enables increase in a burst pressure of the hose (100).

The intermediate layer (104) may be circumferentially situated over the extruded inner layer (102). The intermediate layer (104) may be circumferentially braided, knitted or spiralled over the extruded inner layer (102). According to an embodiment, the intermediate layer (104) may be knitted using a knitting machine having at least one first error prevention device. For the purpose of explanation, the first error prevention device may include a sensor at each yarn of the reinforcement material to stop the knitting machine in case of missing yarn or yarn break.

According to an embodiment, the reinforcement material of the intermediate layer (104) is selected from a group consisting of polyester, nylon, and aramid. The intermediate layer (104) may have has a second inner circumferential surface and a second outer circumferential surface. The second inner circumferential surface of the intermediate layer (104) may be telescoped over the first outer circumferential surface of the extruded inner layer (102).

The extruded inner layer (102) along with the intermediate layer (104) may be passed through a hot channel to soften the first TPV. According to an embodiment, the hot channel may have a temperature in a range of 200° C. to 300° C. For the purpose of explanation, the hot channel may be a hot air tunnel from which the extruded inner layer (102) along with the intermediate layer (104) is passed to soften the first TPV.

The hose (100) may include an extruded outer layer (106) made of a second thermoplastic vulcanizate (TPV). The extruded outer layer (106) may work as a cover of the hose (100). The second TPV may be extruded at a temperature range of 170° C. to 240° C. to form the extruded outer layer (106) of the hose (100). According to an embodiment, the extruded outer layer (106) may have a substantially cylindrical shape. According to another embodiment, the extruded outer layer (106) may be of any customized shape. It will be appreciated by a person skilled in the art that the shape and size of the extruded outer layer (106) may vary according to the overall design of the hose (100), and may not be limited to the embodiment shown in the figures. Moreover, it should be noted that the extruded outer layer (106) may be made of the second TPV which enables reduction in overall weight of the hose (100) and provides resistance against environmental and physical degradation. According to an embodiment, the second TPV may have a hardness between about 64 shore A and 87 shore A. According to another embodiment, the second TPV may have the hardness between 40 shore D and 50 shore D.

According to an embodiment, the first TPV and the second TPV may be extruded in extrusion equipment having at least one second error prevention device. The second error prevention device may include but not limited to a laser micrometer to control outer diameter, an automatic temperature controller and an inner diameter controller. For the purpose of explanation, the laser micrometer may come with standard extrusion software inside a controller which controls the outer diameter and automatically regulate the extrusion process. Additionally, the automatic temperature controller may stop the extrusion equipment if temperature of the extrusion process is out of tolerance. Further, the inner diameter controller may prevent excessive air.

The extruded outer layer (106) may be circumferentially situated over the intermediate layer (104). The extruded outer layer (106) may have a third inner circumferential surface and a third outer circumferential surface. The third inner circumferential surface of the extruded outer layer (106) may be telescoped over the second outer circumferential surface of the intermediate layer (104). According to an embodiment, a vacuum pressure may be applied during extrusion of the second TPV to form the extruded outer layer (106) and provide adhesive strength to the hose (100). The vacuum pressure may be about 620 millimeter of mercury.

According to an embodiment, the hose (100) may exhibit the burst pressure in a range of 15 bars to 29 bars. The hose (100) may further exhibit no cracks and no fissures when tested for fluid ageing resistance. For the purpose of explanation, when the fluid having the temperature in a range of 110° C. to 130° C. is filled in the hose (100) for 3 hours, the hose (100) exhibits no cracks and no fissures. Additionally, the hose (100) may be flared at one end or both ends of the hose (100). The hose (100) may further eliminate probability of under curing defects, porosity defects and the like. Moreover, the hose (100) may have adhesion strength in a range of 6 Kgf/in to 9 Kgf/in with speed of 50 mm/min.

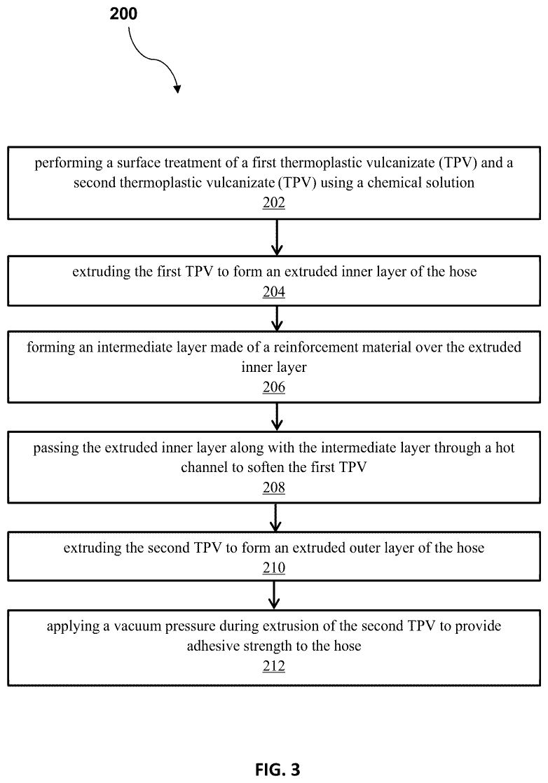

Referring now to FIG. 3, a flowchart for a method (200) of manufacturing the hose (100) is illustrated, in accordance with another exemplary embodiment of the present invention. The method (200) for manufacturing the hose (100) may include a step (202) of performing the surface treatment of the first TPV and the second TPV using the chemical solution. The chemical solution may be the combination of Toluene, Cyclohexane, Tetra Hydrofuran (THF) and Methoxyropyl Acetate.

The method (200) for manufacturing the hose (100) may further include a step (204) of extruding the first TPV to form the extruded inner layer (102) of the hose (100). The first TPV may have the density of about 0.90 gram per cubic centimeter. The extruded inner layer (102) may have the first inner circumferential surface and the first outer circumferential surface. According to an embodiment of the present invention, the first TPV may be extruded at the temperature range of 170° C. to 240° C. to form the extruded inner layer (102) of the hose (100).

The method (200) for manufacturing the hose (100) may further include a step (206) of forming the intermediate layer (104) made of the reinforcement material over the extruded inner layer (102.) The intermediate layer may have the second inner circumferential surface and the second outer circumferential surface. According to an embodiment of the present invention, the intermediate layer (104) may be braided, knitted or spiralled over the extruded inner layer (102). The reinforcement material may be selected from the group consisting of polyester, nylon, and aramid.

The method (200) for manufacturing the hose (100) may further include a step (208) of passing the extruded inner layer (102) along with the intermediate layer (104) through the hot channel to soften the first TPV. According to an embodiment of the present invention, the hot channel may have the temperature in a range of 200° C. to 300° C.

The method (200) for manufacturing the hose (100) may further include a step (210) of extruding the second TPV to form the extruded outer layer (106) of the hose (100). The second TPV may have the density of about 0.90 gram per cubic centimeter. The extruded outer layer (106) may have the third inner circumferential surface and the third outer circumferential surface. According to an embodiment of the present invention, the second TPV may be extruded at the temperature range of 170° C. to 240° C. to form the extruded outer layer (106) of the hose (100).

The method (200) for manufacturing the hose (100) may further include a step (212) of applying the vacuum pressure during extrusion of the second TPV to provide the adhesive strength to the hose (100). According to an embodiment of the present invention, the vacuum pressure may be about 620 millimeter of mercury.

The method (200) for manufacturing the hose (100) may further include a step of cooling the extruded inner layer (102) and the extruded outer layer (106) in the tank filled with water. Furthermore, the method (200) for manufacturing the hose (100) may include a step of applying the releasing agent on the mandrel for mounting and removal of the extruded inner layer (102), the intermediate layer (104) and the extruded outer layer (106). According to an embodiment of the present invention, the releasing agent may be selected from a group consisting of polyether, ester oil, non-ionic surfactants, polyglycol mixture, ethylene glycol, and propylene glycol.

Moreover, the method (200) for manufacturing the hose (100) may include a step of mounting the extruded inner layer (102), the intermediate layer (104 and the extruded outer layer (106) on the mandrel on which the releasing agent is applied. The method (200) for manufacturing the hose (100) may also include a step of processing the extruded inner layer (102), the intermediate layer (104) and the extruded outer layer (106) mounted on the mandrel in the autoclave to shape the hose (100) at a temperature range of 150° C. to 170° C. for 35 minutes.

### Example 1

The hose 100 described above has been tested to determine its properties. The test was carried out in below condition.

| | |
|---|---|
| Test Plate conditions | By Injection moulding; Mould Temp: |
| | 200° C., Mould time: 45 seconds |
| Test Plate Size | 150 (L) × 100 (W) × 2 mm thickness |
| Dumb-bell Size | 75 mm |

Below is the summary of the tests carried out on the hose 100 and its effect caused on the hose 100.

| | | | IAI R&D TEST |
|---|---|---|---|
| Sr. No. | TESTS | UNIT | RESULTS |
| i | Standard (OEM) | | |
| 1 | POLYMER | FT-IR Spectroscoy | TPV |
| 2 | ORIGINAL PHYSICAL | | |
| | PROPERTIES | | |
| 2.1 | DENSITY | g/cm3 | 0.902 |
| 2.2 | HARDNESS | Shore A | 94 |
| 2.3 | HARDNESS | Shore A 3 s | 94 |
| 2.3 | IRHD HARDNESS | IRHD | 93.1 |
| 2.4 | TENSILE STRENGTH | MPa | 11.3 |
| 2.5 | ELONGATION AT | % | 575 |
| | BREAK | | |
| 2.6 | MODULUS @100% | Kg/cm2 | 50 |
| | ELONGATION | | |
| 2.7 | TEAR STRENGTH TYPE | N/mm | 15.38 |
| | A (TROUSER) (TEST | | |
| | SPEED 100 mm/mim); | | |
| 2.8 | TEAR STRENGTH TYPE | N/mm | 42.6 |
| | B (CRECENT | | |
| | WITHOUT NICK (TEST | | |
| | SPEED 100 mm/mim); | | |
| 2.9 | TEAR STRENGTH | kN/M | 48.7, 48.9, 48.9 |
| | ANGULAR (TYPE-C) | | |
| | (TEST SPEED | | |
| | 100 mm/mim); | | |
| 2.10 | TEAR STRENGTH | N/mm | 25.7, 24.5 |
| | DELFT TYPE (TEST | | |
| | SPEED 100 mm/mim); | | |
| | min. | | |
| 4 | COMPRESSION SET | | |
| 4.1 | COMPRESSION SET @ | | 60.0 |
| | 70° C. × 22 hrs (THREE | | |
| | LAYERS ) | | |
| | COMPRESSED 25% | | |
| | METHOD B, max | | |
| 4.6 | COMPRESSION SET AT | % | NO CRACKS |
| | LOW TEMPERATURE: −40 °C. × | | |
| | 5 hrs | | |
| 5 | AFTER HEAT AGEING | | |
| | @150° C. × 70 Hrs | | |
| 5.1 | CHANGE IN IRHD | IRHD points | +0.5 |
| 5.2 | CHANGE IN | Shore A Point | −3 |
| | HARDNESS | | |
| 5.3 | TENSILE STRENGTH | MPa | 8.7 |
| 5.4 | CHANGE IN TENSILE | % | −21.24 |
| | STRENGTH | | |
| 5.5 | ELONGATION AT | % | 400 |
| | BREAK | | |
| 5.6 | CHANGE IN | % | −30.43 |
| | ELONGATION | | |
| 6 | AFTER HEAT AGEING | | |
| | @150° C. × 168 Hrs | | |
| 6.1 | CHANGE IN IRHD, max | IRHD Points | +2.9 |
| 6.2 | CHANGE IN | Shore A Point | +1 |
| | HARDNESS, max | | |
| 6.3 | TENSILE STRENGTH, | MPa | 9.7 |
| | min | | |
| 6.4 | CHANGE IN TENSILE | % | −12.39 |
| | STRENGTH, max | | |
| 6.5 | ELONGATION, min. | % | 400 |
| 6.6 | CHANGE IN | % | −30.43 |
| | ELONGATION, max | | |
| 6.7 | CHANGE IN VOLUME, | % | −7.47 |
| | max | | |
| 6.8 | CHANGE IN MASS, | % | −3.98 |
| REPEAT | CHANGE IN VOLUME, | % | −9.88 |
| | max | | |
| REPEAT | CHANGE IN MASS, | % | −4.98 |
| 7 | AFTER HEAT AGEING | | |
| | @135° C. × 168 Hrs | | |
| 7.1 | CHANGE IN IRHD, max | IRHD Points | −0.4 |
| 7.2 | CHANGE IN | Shore A Point | −1 |
| | HARDNESS, max | | |
| 7.3 | CHANGE IN TENSILE | % | −9.73 |
| | STRENGTH, max | | |
| 7.4 | CHANGE IN | % | −13.04 |
| | ELONGATION, max | | |
| 7.5 | MODULUS @100% | % | 47 |
| | ELONGATION | | |
| 7.6 | CHANGE IN TEAR | % | −7.3 |
| | STRENGTH ANGULAR | | |
| | (TYPE-C) (TEST SPEED | | |
| | 100 mm/mim); maximum | | |
| ADDITIONAL | TEAR TYPE A | N/mm | 13.86, 15.42 |
| | (TROUSER) | | |
| ADDITIONAL | CHANGE IN VOLUME, | % | −7.32 |
| | max | | |
| ADDITIONAL | CHANGE IN MASS, | % | −3.01 |
| 8 | AFTER HEAT AGEING | | |
| | @135° C. × 42 Days | | |
| 8.1 | CHANGE IN IRHD, max | IRHD Points | +1.8 |
| 8.2 | CHANGE IN | Shore A Point | +1 |
| | HARDNESS, max | | |
| 8.3 | TENSILE STRENGTH | MPa | 10.8 |
| 8.4 | CHANGE IN TENSILE | % | −2.65 |
| | STRENGTH, max | | |
| 8.5 | ELONGATION | % | 475 |
| 8.6 | CHANGE IN | % | −17.39 |
| | ELONGATION, max | | |
| 8.7 | CHANGE IN VOLUME, | % | ~~ |
| | max | | |
| 9 | AFTER HEAT AGEING | | |
| | @125 C. × 70 hrs | | |
| 9.1 | CHANGE IN IRHD, max | IRHD Points | +0.9 |
| 9.2 | CHANGE IN | Shore A Point | +1 |
| | HARDNESS, max | | |
| 9.3 | TENSILE STRENGTH | MPa | 10.9 |
| 9.4 | CHANGE IN TENSILE | % | −3.54 |
| | STRENGTH, max | | |
| 9.5 | ELONGATION | % | 550 |
| 9.6 | CHANGE IN | % | −4.35 |
| | ELONGATION, max | | |
| 10 | AFTER HEAT AGEING | | |
| | @120° C. × 1008 Hrs | | |
| 10.1 | CHANGE IN IRHD, max | IRHD Points | +1.5 |
| 10.2 | HARDNESS | Shore A | 95 |
| 10.3 | CHANGE IN | Point | +1 |
| | HARDNESS, max | | |
| 10.4 | TENSILE STRENGTH, | MPa | 10.8 |
| | min. | | |
| 10.5 | CHANGE IN TENSILE | % | −2.65 |
| | STRENGTH, max | | |
| 10.6 | ELONGATION, min | % | 450 |
| 10.7 | CHANGE IN | % | −21.74 |
| | ELONGATION, max | | |
| 10.8 | CHANGE IN MASS, | % | ~~ |
| ADDITIONAL | AFTER HEAT AGEING | | |
| | @120° C. × 168 Hrs | | |
| ADDITIONAL | CHANGE IN VOLUME, | % | −5.42 |
| | max | | |
| ADDITIONAL | CHANGE IN MASS, | % | −1.43 |
| 11 | AFTER COOLANT | | |
| | AGEING GLYSANTIN | | |
| | G40 (RTU) (50:50) from | | |
| | BASF; AGEING @100 | | |
| | C. × 72 Hrs | | |
| 11.1 | CHANGE IN IRHD, max | IRHD Points | −1 |
| 11.2 | CHANGE IN | Shore A Point | −2 |
| | HARDNESS, max | | |
| 11.3 | CHANGE IN TENSILE | % | −0.88 |
| | STRENGTH, max | | |
| 11.4 | CHANGE IN | % | −4.35 |
| | ELONGATION, max | | |
| 11.6 | CHANGE IN VOLUME, | % | +5.20 |
| | max | | |
| 11.7 | CHANGE IN WEIGHT, | % | −1.01 |
| | max | | |
| 12 | AFTER COOLANT | | |
| | AGEING GLYSANTIN | | |
| | G40 (RTU) (50:50) from | | |
| | BASF; AGEING @100 | | |
| | C. × 168 Hrs | | |
| 12.1 | CHANGE IN IRHD, max | IRHD Points | +0.5 |
| 12.2 | CHANGE IN | Shore A Point | −3 |
| | HARDNESS, max | | |
| 12.3 | CHANGE IN TENSILE | % | −25.66 |
| | STRENGTH, max | | |
| 12.4 | CHANGE IN | % | −21.74 |
| | ELONGATION, max | | |
| 12.5 | MODULUS @100% | MPa | 4.3 |
| | ELONGATION | | |
| 12.6 | CHANGE IN TEAR | % | −7.1 |
| | STRENGTH ANGULAR | | |
| | (TYPE-C) (TEST SPEED | | |
| | 100 mm/mim); maximum | | |
| 12.7 | CHANGE IN VOLUME, | % | +10.50 |
| | max | | |
| 12.8 | CHANGE IN WEIGHT, | % | +1.19 |
| | max | | |
| REPEAT | AFTER COOLANT | | |
| | AGEING GLYSANTIN | | |
| | G40 (RTU) (50:50) from | | |
| | BASF; AGEING @ 100 C. × | | |
| | 168 Hrs | | |
| REPEAT | CHANGE IN IRHD, max | IRHD Points | −3.3 |
| REPEAT | CHANGE IN | Shore A Point | −1 |
| | HARDNESS, max | | |
| REPEAT | CHANGE IN TENSILE | % | −7.08 |
| | STRENGTH, max | | |
| REPEAT | CHANGE IN | % | −13.04 |
| | ELONGATION, max | | |
| REPEAT | MODULUS @100% | MPa | 5.1 |
| | ELONGATION | | |
| REPEAT | CHANGE IN TEAR | % | −6.8 |
| | STRENGTH ANGULAR | | |
| | (TYPE-C) (TEST SPEED | | |
| | 100 mm/mim); maximum | | |
| REPEAT | CHANGE IN VOLUME, | % | +1.01 |
| | max | | |
| REPEAT | CHANGE IN WEIGHT, | % | +0.78 |
| | max | | |
| 13 | AFTER COOLANT | | |
| | ETHYLENE GLYCOL + | | |
| | WATER (75 + 25%) | | |
| | AGEING @135° C. × 168 | | |
| | Hrs | | |
| 13.1 | CHANGE IN IRHD, max | IRHD Points | −0.4 |
| 13.2 | CHANGE IN | Shore A Point | −2 |
| | HARDNESS, max | | |
| 13.3 | CHANGE IN | Shore A 3 s Point | 0 |
| | HARDNESS, max | | |
| 13.3 | CHANGE IN TENSILE | % | −8.85 |
| | STRENGTH, max | | |
| 13.4 | ELONGATION AT | % | 450 |
| | BREAK, min. | | |
| 13.5 | CHANGE IN | % | −21.74 |
| | ELONGATION, max | | |
| 13.6 | CHANGE IN VOLUME, | % | +1.76 |
| | max | | |
| 13.7 | CHANGE IN WEIGHT, | % | +1.64 |
| | max | | |
| 14 | AFTER COOLANT | | |
| | AGEING GLYSANTIN | | |
| | G40 (RTU) (50:50) from | | |
| | BASF; @125 C. × | | |
| | 1008 Hrs | | |
| 14.1 | CHANGE IN IRHD, max | | +0.6 |
| 14.2 | CHANGE IN | Shore A Point | −2 |
| | HARDNESS, max | | |
| | TENSILE | MPa | 10.1 |
| | STRENGTH, max | | |
| 14.3 | CHANGE IN TENSILE | % | −8.85 |
| | STRENGTH, max | | |
| 14.4 | CHANGE IN | % | −21.74 |
| | ELONGATION, max | | |
| | ELONGATION, max | % | 450 |
| 14.5 | CHANGE IN VOLUME, | % | +0.78 |
| | max | | |
| 14.6 | CHANGE IN WEIGHT, | % | +0.23 |
| | max | | |
| 15 | AFTER COOLANT | | RUNNING |
| | G40 (RTU) AGEING | | |
| | @100 C. × 3000 Hrs | | |
| 15.1 | CHANGE IN IRHD, max | IRHD Points | −0.9 |
| 15.2 | CHANGE IN | Shore A Point | −1 |
| | HARDNESS, max | | |
| 15.3 | CHANGE IN TENSILE | % | −3.37 |
| | STRENGTH, max | | |
| 15.4 | CHANGE IN | % | 0 |
| | ELONGATION, max | | |
| 15.5 | CHANGE IN VOLUME, | % | −4.24 |
| | max | | |
| 15.6 | CHANGE IN WEIGHT, | % | −3.32 |
| | max | | |
| 16 | AFTER BRAKE FLUID | | |
| | (DOT-4) AGEING | | |
| | @125° C. × 168 Hrs | | |
| 16.1 | CHANGE IN IRHD, max | IRHD Points | −5.2 |
| 16.2 | CHANGE IN | Shore A 3 s Point | 0 |
| | HARDNESS, max | | |
| 16.3 | CHANGE IN TENSILE | % | −3.54 |
| | STRENGTH, max | | |
| 16.4 | ELONGATION | % | 450 |
| 16.5 | CHANGE IN | % | −21.74 |
| | ELONGATION, max | | |
| 16.6 | CHANGE IN VOLUME, | % | +3.50 |
| | max | | |
| 16.7 | CHANGE IN WEIGHT, | % | +2.12 |
| | max | | |
| 17 | AFTER WINDSHIELD | | |
| | WASHER FLUID (70% | | |
| | WATER + 30% 2- | | |
| | PROPANOL) AGEING | | |
| | @70° C. × 70 Hrs | | |
| 17.1 | CHANGE IN IRHD, max | IRHD Points | −0.5 |
| 17.2 | CHANGE IN | Shore A 3 s Point | −1 |
| | HARDNESS, max | | |
| 17.3 | CHANGE IN TENSILE | % | −7.08 |
| | STRENGTH, max | | |
| 17.4 | ELONGATION | % | 550 |
| 17.5 | CHANGE IN | % | −4.35 |
| | ELONGATION, max | | |
| 17.6 | CHANGE IN VOLUME, | % | +0.42 |
| | max | | |
| 17.7 | CHANGE IN WEIGHT, | % | +0.205 |
| | max | | |
| 18 | AFTER MINERAL OIL | | |
| | SAE 30 @ | | |
| | 100° C. × 24 Hrs | | |
| 18.1 | CHANGE IN IRHD, max | IRHD Points | −10.7 |
| 18.2 | CHANGE IN | Shore A Point | −15 |
| | HARDNESS, max | | |
| 18.3 | CHANGE IN VOLUME, | % | +84.01 |
| | max | | |
| 18.4 | CHANGE IN WEIGHT, | % | +28.93 |
| | max | | |
| 19 | OZONE RESISTANCE | | |
| | TEST | | |
| 19.1 | OZONE @ 50 pphm × | ~~ | No Cracked |
| | 40° C. × 48 Hrs × 20% | | |
| | Elong | | |
| 19.2 | OZONE @ 100 pphm × | ~~~~ | No Cracked |
| | 40° C. × 70 Hrs × 15% | | |
| | Elong | | |
| 19.3 | OZONE @ 200 pphm × | ~~~~ | No Cracked |
| | 40° C. × 70 Hrs × 20% | | |
| | Elong | | |

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claims.

1. A method (200) of manufacturing a hose (100), the method (200) comprising:
performing a surface treatment of a first thermoplastic vulcanizate (TPV) and a second thermoplastic vulcanizate (TPV) using a chemical solution;
extruding the first TPV to form an extruded inner layer (102) of the hose (100);
forming an intermediate layer (104) made of a reinforcement material over the extruded inner layer (102);
passing the extruded inner layer (102) along with the intermediate layer (104) through a hot channel to soften the first TPV;
extruding the second TPV to form an extruded outer layer (106) of the hose (100); and
applying a vacuum pressure during extrusion of the second TPV to provide adhesive strength to the hose (100).

2. The method (200) as claimed in claim 1, wherein the extruded inner layer (102) has a first inner circumferential surface and a first outer circumferential surface, the intermediate layer (104) has a second inner circumferential surface and a second outer circumferential surface, the extruded outer layer (106) has a third inner circumferential surface and a third outer circumferential surface.

3. The method (200) as claimed in claim 1, wherein the first TPV is extruded at a temperature range of 170° C. to 240° C. to form the extruded inner layer (102) of the hose (100).

4. The method (200) as claimed in claim 1, wherein the intermediate layer (104) is braided, knitted or spiralled over the extruded inner layer (102).

5. The method (200) as claimed in claim 1, wherein the reinforcement material is selected from a group consisting of polyester, nylon, and aramid.

6. The method (200) as claimed in claim 1, wherein the second TPV is extruded at a temperature range of 170° C. to 240° C. to form the extruded outer layer (106) of the hose (100).

7. The method (200) as claimed in claim 1, wherein the chemical solution is a combination of Toluene, Cyclohexane, Tetra Hydrofuran (THF) and Methoxyropyl Acetate.

8. The method (200) as claimed in claim 1, wherein the hot channel is having a temperature in a range of 200° C. to 300° C.

9. The method (200) as claimed in claim 1, wherein the first TPV and the second TPV each has a density of about 0.90 gram per cubic centimeter.

10. The method (200) as claimed in claim 1, wherein the hose (100) exhibits minimum burst pressure of 10 bars.

11. The (200) method as claimed in claim 1, wherein the vacuum pressure is about 620 millimeter of mercury.

12. The method (200) as claimed in claim 1, further comprising cooling the extruded inner layer (102) and the extruded outer layer (106) in a tank filled with water.

13. The method (200) as claimed in claim 1, the method (200) further comprising:
applying a releasing agent on a mandrel for mounting and removal of the extruded inner layer (102), the intermediate layer (104) and the extruded outer layer (106), the releasing agent is selected from a group consisting of polyether, ester oil, non-ionic surfactants, polyglycol mixture, ethylene glycol, and propylene glycol;
mounting the extruded inner layer (102), the intermediate layer (104) and the extruded outer layer (106) on the mandrel on which the releasing agent is applied; and
processing the extruded inner layer (102), the intermediate layer (104) and the extruded outer layer (106) mounted on the mandrel in an autoclave to shape the hose (100) at a temperature range of 150° C. to 170° C. for 35 minutes.

14. A hose (100), comprising:
an extruded inner layer (102) made of a first TPV, the extruded inner layer (102) provides a path for flow of a fluid;
an intermediate layer (104) made of a reinforcement material, the intermediate layer (104) is circumferentially situated over the extruded inner layer (102); and
an extruded outer layer (106) made of a second TPV, the extruded outer layer (106) is circumferentially situated over the intermediate layer (104),
wherein the first TPV and the second TPV are surface treated using a chemical solution.

15. The hose (100) as claimed in claim 14, wherein the extruded inner layer (102) has a first inner circumferential surface and a first outer circumferential surface, the intermediate layer (104) has a second inner circumferential surface and a second outer circumferential surface, the extruded outer layer (106) has a third inner circumferential surface and a third outer circumferential surface.

16. The hose (100) as claimed in claim 14, wherein the extruded inner layer (102) along with the intermediate layer (104) is passed through a hot channel to soften the first TPV, the hot channel is having a temperature in a range of 200° C. to 300° C.

17. The hose (100) as claimed in claim 14, wherein a vacuum pressure is applied during extrusion of the second TPV to provide adhesive strength to the hose (100), the vacuum pressure is about 620 millimeter of mercury.

18. The hose (100) as claimed in claim 14, wherein the first TPV is extruded at a temperature range of 170° C. to 240° C. to form the extruded inner layer (102) of the hose (100).

19. The hose (100) as claimed in claim 14, wherein the intermediate layer (104) is circumferentially braided, knitted or spiralled over the extruded inner layer (102).

20. The hose (100) as claimed in claim 14, wherein the reinforcement material is selected from a group consisting of polyester, nylon, and aramid.

21. The hose (100) as claimed in claim 14, wherein the second TPV is extruded at a temperature range of 170° C. to 240° C. to form the extruded outer layer (106) of the hose (100).

22. The hose (100) as claimed in claim 14, wherein the chemical solution is a combination of Toluene, Cyclohexane, Tetra Hydrofuran (THF) and Methoxyropyl Acetate.

23. The hose (100) as claimed in claim 14, wherein the first TPV and the second TPV each has a density of about 0.90 gram per cubic centimeter.

24. The hose (100) as claimed in claim 14, wherein the hose (100) exhibits minimum burst pressure of 10 bars.
